(19) United States
(12) Patent Application Publication
(10) Pub. No.: US 2017/0034988 A1
(43) Pub. Date: Feb. 9, 2017

(54) Surface Conditioning System

(71) Applicant: Harry Meredith, Guelph (CA)

(72) Inventor: Harry Meredith, Guelph (CA)

(21) Appl. No.: 14/819,848

(22) Filed: Aug. 6, 2015

(51) Int. Cl. A01B 49/02; A01B 23/04; A01B 19/02

(52) U.S. Cl. CPC A01B 49/02; A01B 19/02; A01B 23/043

(57) ABSTRACT

A conditioning system for conditioning a ground surface having a base layer and a cushion layer. The conditioning system includes at least one conditioning element adapted for conditioning the ground surface, a floating frame adapted for supporting the at least one conditioning system to maintain desired contact with the ground surface, and a levelling system for defining a desired spacing between a base layer of the ground surface and the at least one conditioning element to define a cushion layer. In one embodiment a first conditioning element and a second conditioning element are provided where the first conditioning element is disposed at a first angle relative to a directional axis and the second conditioning element is disposed at a second angle relative to the directional axis and wherein the first conditioning element is offset from the second conditioning element relative to the directional axis.

### FIELD

This specification relates to surface conditioning systems and in particular to systems adapted for conditioning ground surfaces, such as horse riding rings, where it is desirous to have a cushion layer disposed over a base layer.

### BACKGROUND

The following background discussion is not an admission that anything discussed below is citable as prior art or common general knowledge. The documents listed below are incorporated herein in their entirety by this reference to them.

Harrows, graders and other systems for conditioning ground surfaces are well known. These systems include conditioning elements, such as grading blades or harrow implements that are adapted to condition the ground surface to a desired level or grade.

A problem with these systems is that they are not adapted for conditioning ground surfaces, such as horse riding rings, where it is desired to have a cushion layer of lightly compacted material disposed over a relatively more packed base layer.

It is further desirable that such systems be relatively easy to use and affordable.

### SUMMARY

In one aspect the invention provides a system adapted for use with a vehicle for conditioning ground surfaces, the system includes:

a first conditioning element adapted for conditioning a ground surface, said first conditioning element being disposed at a first angle relative to a directional axis; and

a second conditioning element adapted for conditioning a ground surface, said second conditioning element being disposed at a second angle relative to said directional axis;

wherein said first conditioning element is offset from said second conditioning element relative to said directional axis.

In another aspect the invention provides a system adapted for use with a vehicle for conditioning ground surfaces, the system includes:

at least one conditioning element adapted for conditioning a ground surface;

a floating frame adapted for supporting said at least one conditioning system to maintain desired contact with the ground surface; and

a levelling system for defining a desired spacing between a base layer of the ground surface and said at least one conditioning element.

In another aspect the invention provides a system adapted for use with a vehicle for conditioning ground surfaces, the system includes:

a support frame having a mounting system for mounting said support frame to a vehicle;

a floating frame suspended from said support frame by a suspension system adapted to maintain desired contact with a ground surface;

a first conditioning element disposed on said floating frame and adapted for conditioning a ground surface, said first conditioning element being disposed at a first angle relative to a directional axis; and

a second conditioning element disposed on said floating frame and adapted for conditioning a ground surface, said second conditioning element being disposed at a second angle relative to said directional axis.

Other aspects and features of the teachings disclosed herein will become apparent, to those ordinarily skilled in the art, upon review of the following description of the specific examples of the specification.

### DRAWINGS

The drawings included herewith are for illustrating various examples of articles, methods, and apparatuses of the present specification and are not intended to limit the scope of what is taught in any way. For simplicity and clarity of illustration, where considered appropriate, reference numerals may be repeated among the drawings to indicate corresponding or analogous elements.

FIG. 1 is a left side view of a conditioning system in accordance with the present invention mounted to a vehicle;

FIG. 2 is a top view of the conditioning system shown in FIG. 1;

FIG. 3 is an enlarged left side view of the conditioning system shown in FIG. 1 together with a schematic sectional view of the ground surface;

FIG. 4 is an enlarged right side view of the conditioning system shown in FIG. 1 together with a schematic sectional view of a ground surface;

FIG. 5 is a perspective view of the conditioning system shown in FIG. 1 together with a schematic sectional view of a ground surface;

FIG. 6 is a schematic side view of a ground surface prior to use of the conditioning system shown in FIG. 1;

FIG. 7 is a top view of a conditioning system in accordance with another embodiment of the invention; and

FIG. 8 is an enlarged sectional view of a third conditioning element as viewed along lines 8-8 in FIG. 7.

### DESCRIPTION OF VARIOUS EMBODIMENTS

Various apparatuses or methods will be described below to provide examples of the claimed invention. The claimed invention is not limited to apparatuses or methods having all of the features of any one apparatus or method described below or to features common to multiple or all of the apparatuses described below. The claimed invention may reside in a combination or sub-combination of the apparatus elements or method steps described below. It is possible that an apparatus or method described below is not an example of the claimed invention. The applicant(s), inventor(s) and/or owner(s) reserve all rights in any invention disclosed in an apparatus or method described below that is not claimed in this document and do not abandon, disclaim or dedicate to the public any such invention by its disclosure in this document.

A conditioning system in accordance with an embodiment of the invention is shown generally at 10 in the Figures. Conditioning system 10 includes a support frame 12 and a floating frame 14.

Support frame 12 includes a mounting system 16 that is adapted for mounting conditioning system 10 to a vehicle 18. Vehicle 18 is adapted to move conditioning system 10 along a desired directional axis A (such as by pulling or pushing conditioning system 10 in a desired forward F or rearward R direction). Vehicle 18 may for example be a tractor and mounting system 16 may be a three point hitch (as shown). Alternatively, vehicle 18 may be a truck or utility vehicle and mounting system 16 may be a ball hitch (not shown). Alternatively, vehicle 18 may be a front end loader or fork lift and mounting system 16 may be a bracket having tubes or slots adapted to receive tines (not shown).

Support frame 12 preferably comprises a central beam 20 that extends from mounting system 16 along directional axis A and one or more cross beams 22 that that are adapted to support floating frame 14. Cross beams 22 are preferably connected to central beam 20 with welds, bolts or the like.

Floating frame 14 preferably comprises side beams 24 that are adapted to suspend floating frame 14 from support frame 12 as described further below. Side beams 24 preferably are also adapted to support one or more conditioning elements 30 and a levelling system 40 as described further below. For example, side beams 24 may extend between a first conditioning element 30a and a second conditioning element 30b to maintain the relative angular orientation of the respective conditioning elements 30 as described further below.

It will be understood that alternate structures for support frame 12 and floating frame 14, such as one or more substantially rigid plates or other structures, may be provided instead of the beam structures described above.

Floating frame 14 is suspended from support frame 12 by a suspension system 26 that is adapted to allow floating frame 14 to move or float relative to support frame 12. This allows elements suspended from floating frame 14, such as conditioning elements 30 and levelling system 40, to maintain contact with a ground surface G when desired. Suspension system 26 includes components 28 extending between support frame 12 and floating frame 14 that are adapted to bias floating frame 14 toward ground surface G relative to support frame 12 by gravity and/or with the aid of resilient or spring biased components. Components 28 for suspension system 26 may include chains (as shown), cables, wires, ropes, springs, pneumatic cylinders or other suitable mechanisms.

Preferably, components 28 are independently height adjustable to allow the orientation of floating frame 14 relative to support frame 12 to be modified. Chains for example may be set at different heights. This allows conditioning elements 30 to be set at different heights to operate at different planes for example. Alternatively, conditioning elements 30 may be set with one side (for example the leading edge) at a different height than the other side (for example the trailing edge).

First conditioning element 30a is disposed on side beams 24 of floating frame 14 at a first angle A1 relative to directional axis A. First conditioning element 30a includes a first leading edge L1 and a first trailing edge T1. Second conditioning element 30b is disposed on side beams 24 of floating frame 14 at a second angle A2 relative to directional axis A. Second conditioning element 30b includes a second leading edge L2 and a second trailing edge T2. First angle Al is one of an acute or obtuse angle and second angle A2 is the other of an acute or obtuse angle. In a preferred embodiment (as shown), first angle Al is acute and second angle A2 is obtuse.

Second leading edge L2 is preferably offset from first trailing edge T1 by a gap C1 along an offset axis OA1 that is parallel to directional axis A. Similarly, first leading edge L1 is preferably offset from second trailing edge T2 by a gap G2 along an offset axis OA2 that is parallel to directional axis A.

Guides 32 are preferably disposed at the outermost edges of conditioning elements 30a and 30b (at leading edges L1 and L2 for example) to mark the outer dimensions of conditioning system 10.

At least one of first and second conditioning elements 30a and 30b comprises a first component 34a that is adapted to engage and redistribute a material from ground surface G as described below. More preferably, at least one of first and second conditioning elements 30a and 30b further comprises a second component 34b that is adapted to extend along ground surface G to smooth and lightly compact ground surface G. Preferably, first component 34a and second component 34b are arranged generally perpendicular to one another in a rigid L-beam structure however other angular orientations may be provided.

A levelling system 40 is disposed on floating frame 14 for spacing conditioning elements 30 a desired distance above a base layer B of ground surface G to define a cushion layer C with a groomed surface S.

Levelling system 40 preferably comprises a plurality of levelling components 42 that are adapted to cut through the cushion layer C and ride on the hard packed base layer B of ground surface G. Levelling components 42 may comprise wheels but preferably comprise vertically disposed plates or shoes 44 that are pivotally connected with a pin 46 to one end of an arm 48 the other end of the arm 48 being connected with a swivel 50 to a support flange 52 disposed on side beam 24. Each levelling component 42 also comprises a lock 54 for locking shoes 44 at one of a plurality of desired positions to set the depth d of cushion layer C.

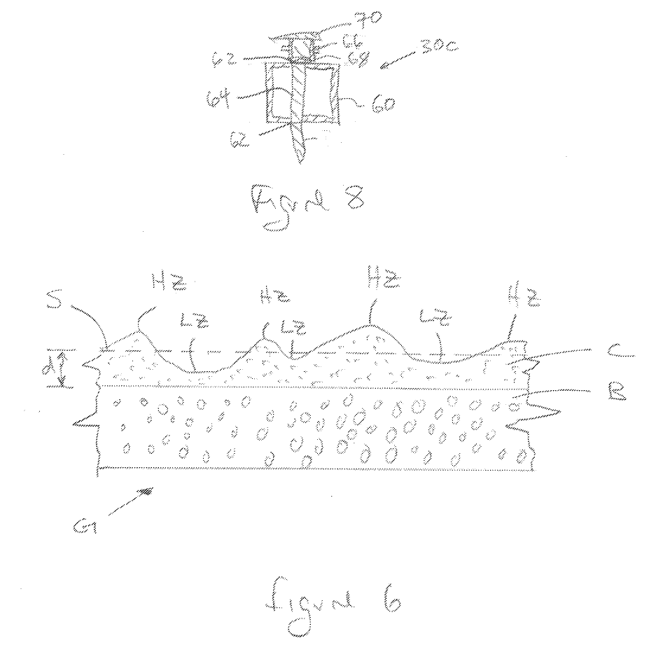

Referring to FIG. 6, a ground surface G is shown having a base layer B and a cushion layer C. Base layer B is relatively hard packed as compared to cushion layer C. Base layer B is preferably formed of hard packed gravel or screenings and cushion layer C is preferably formed of loosely packed material such as sand, wood shavings, rubber pellets or other suitable cushioning materials. Ground surface G further includes high zones HZ and low zones LZ that are typically formed in cushion layer C (in the case of a horse riding ring for example) by human or animal footprints, vehicle tracks etc. Conditioning system 10 is provided to condition ground surface G periodically in order to provide a cushion layer C having a consistent desired depth d with little or no high zones HZ and low zones LZ.

In one embodiment, conditioning system 10 operates as follows. Conditioning system 10 is mounted to vehicle 18 with a three point hitch style of mounting system 16. Levelling components 42 of levelling system 40 are set to a desired depth for defining cushion layer C. Vehicle 18 is then operated to move conditioning system 10 in a first direction F along directional axis A. As vehicle 18 moves, levelling components 42 engage the surface of base layer B thus positioning first and second conditioning elements 30a and 30b a distance d above base layer B. Material M from cushion layer C that is disposed in high zones HZ will contact first component 34a of first conditioning element 30a and be guided towards first trailing edge T1. Material M then exits first trailing edge T1 and contacts first component 34a of second conditioning element 30b where it is guided to second trailing edge T2 where it eventually exits. It will be understood that at least a portion, if not all, of material M may be deposited back onto low zones LZ on cushion layer C as it is guided along first conditioning element 30a and second conditioning element 30b. Second components 34b of first and second conditioning elements 30a and 30b act to smooth and lightly compact the surface S of cushion layer C. As a result, conditioning system 10 produces a conditioned ground surface G having a cushion layer C with a groomed surface S having a relatively consistent depth d with little or no high zones HZ and low zones LZ.

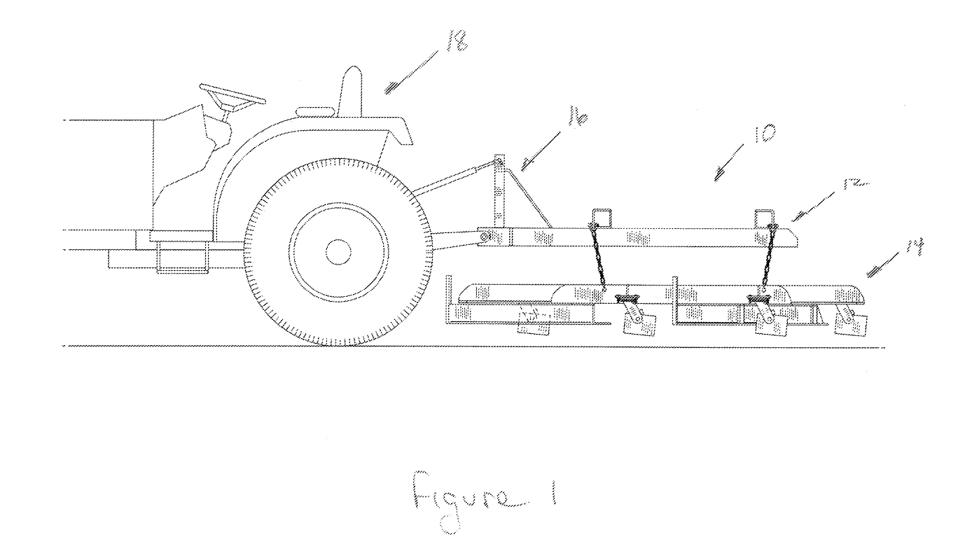

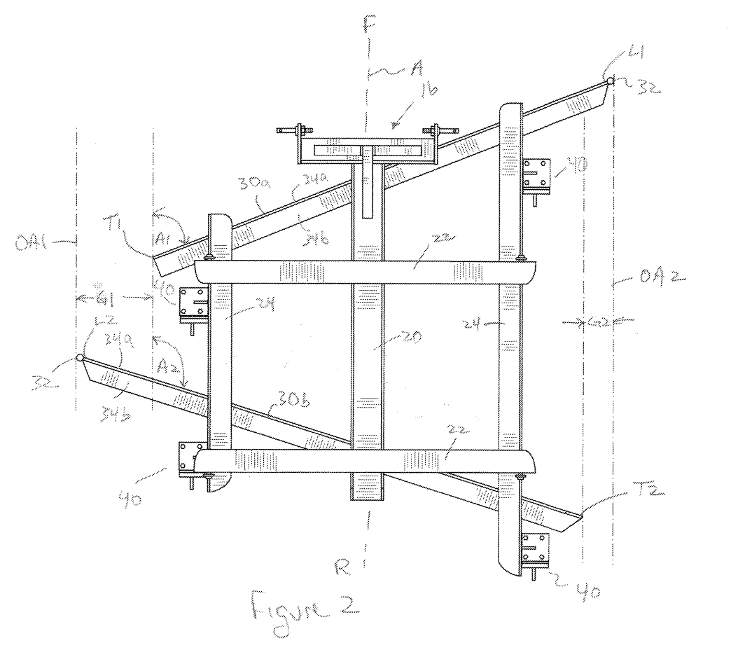

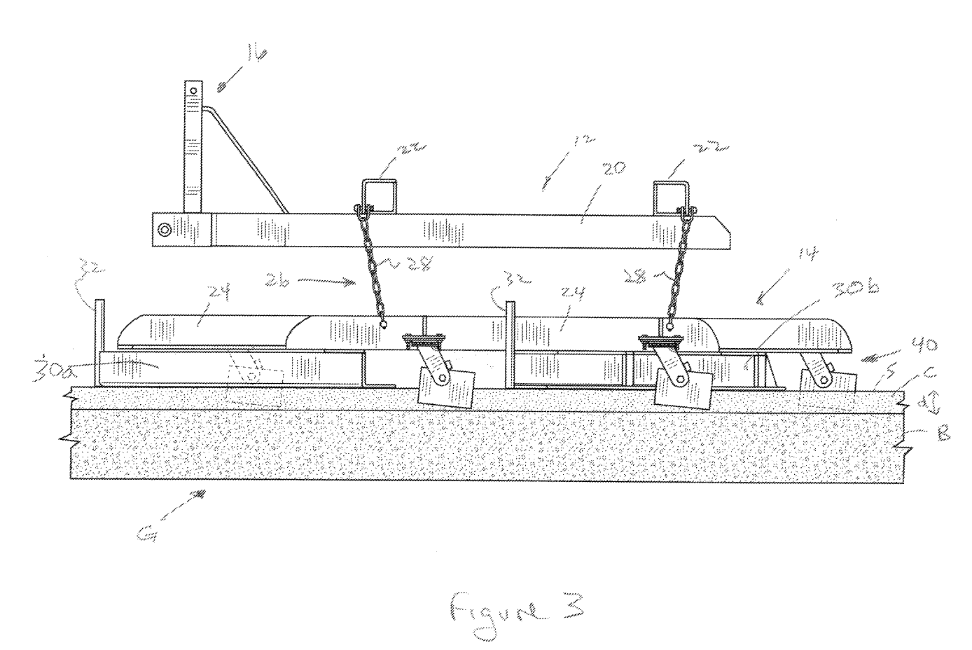

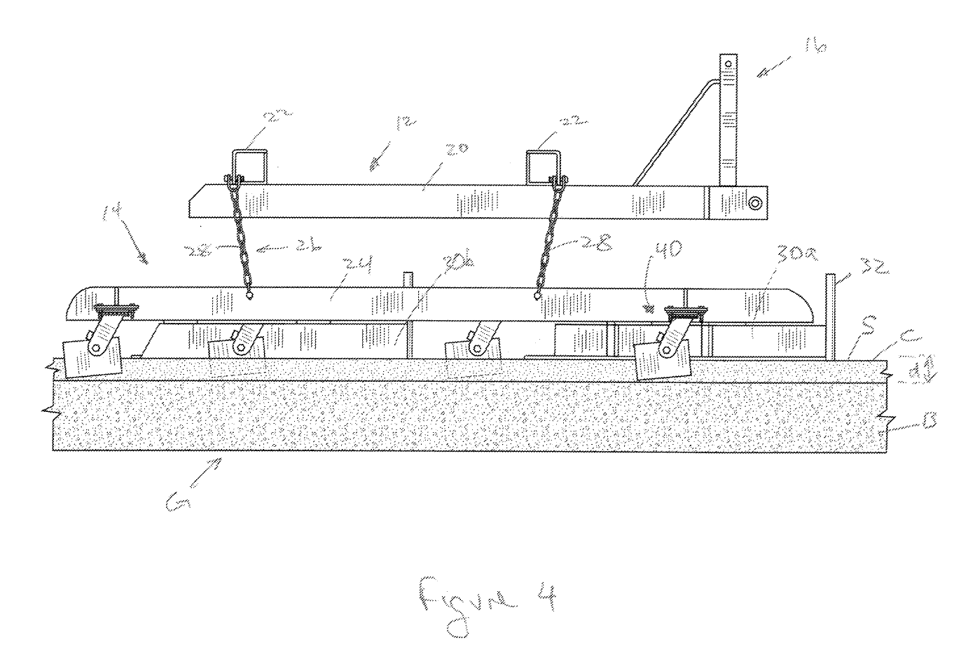

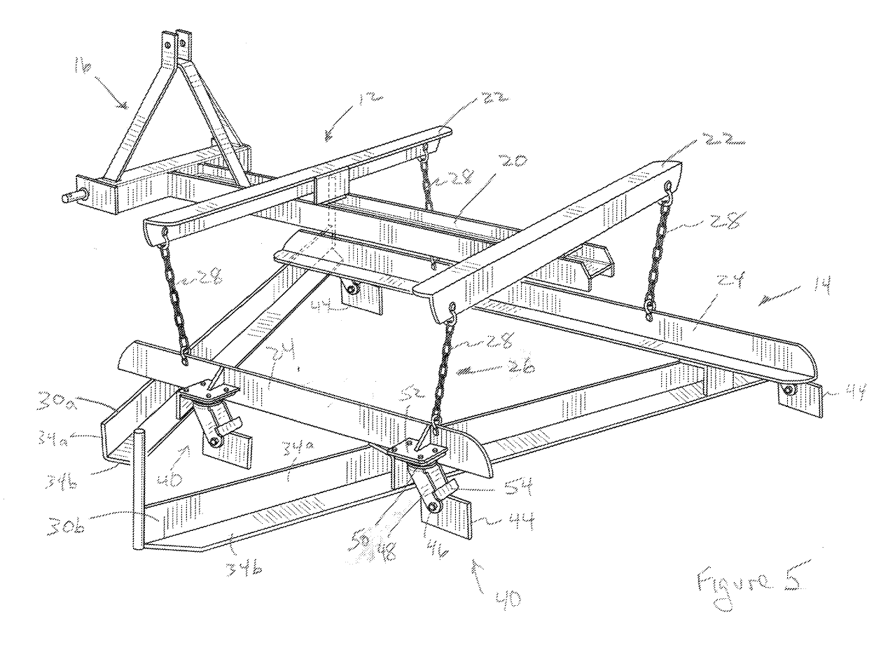

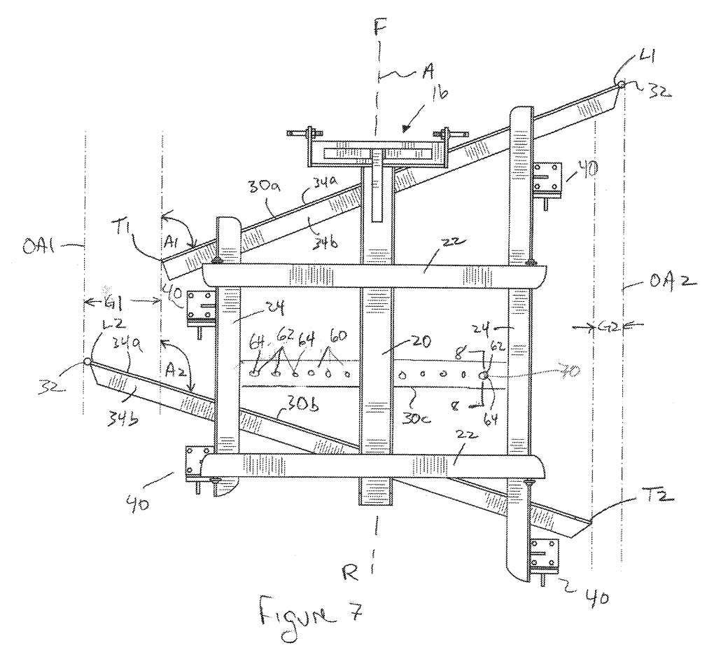

Referring to FIGS. 7 and 8, another embodiment of conditioning system 10 is shown. The same reference numerals are used to refer to similar elements depicted in the embodiment shown in FIGS. 1-5.

Conditioning system 10 includes a third conditioning element 30c extending between side beams 24. Conditioning element 30c may be any desirable implement for conditioning ground surface G.

For the embodiment depicted in FIGS. 7 and 8, conditioning element 30c comprises a harrow implement having a support beam 60 with a plurality of apertures 62 adapted to receive tines 64. Tines 64 are preferably removably attached to support beam with a locking pin 66 and a height adaptor 68 (such as a removable collar) disposed below a head 70 of each tine 64. Third conditioning element 30c thus is adapted to break up the material of ground surface G and collect or dislodge larger objects such as sticks or large rocks. Conditioning element 30c is preferably disposed between first conditioning element 30a and second conditioning element 30b.

It will be understood that the configuration of conditioning system 10 may be altered to include additional or alternative configurations and arrangements of conditioning elements 30. Conditioning elements 30 may additionally or alternatively include rollers, chain harrows or other implements for conditioning the ground surface G.

While the above description provides examples of one or more processes or apparatuses, it will be appreciated that other processes or apparatuses may be within the scope of the accompanying claims.

I/We claim:

1. A system adapted for use with a vehicle for conditioning ground surfaces, the system comprising:
a first conditioning element adapted for conditioning a ground surface, said first conditioning element being disposed at a first angle relative to a directional axis; and
a second conditioning element adapted for conditioning a ground surface, said second conditioning element being disposed at a second angle relative to said directional axis;
wherein said first conditioning element is offset from said second conditioning element relative to said directional axis.

2. The system of claim 1, wherein said first conditioning element has a trailing edge that is offset from a leading edge of said second conditioning element relative to said directional axis.

3. The system of claim 1, wherein said first conditioning element is disposed in the same plane as said second conditioning element.

4. The system of claim 1, wherein said first conditioning element and said second conditioning element are each adapted to engage and redistribute a material from the ground surface.

5. The system of claim 1 wherein at least one of said first conditioning element and said second conditioning element comprises a first component that is adapted to engage and redistribute a material from the ground surface.

6. The system of claim 5 wherein at least one of said first conditioning element and said second conditioning element comprises a second component that is adapted to extend along ground surface to smooth and lightly compact the ground surface.

7. The system of claim 6 wherein said first component and said second component are generally perpendicular to one another.

8. The system of claim 1, wherein said first angle is one of an acute angle and an obtuse angle relative to said directional axis.

9. The system of claim 8, wherein said second angle is the other of an acute angle and an obtuse angle relative to the directional axis.

10. The system of claim 1, further comprising a levelling system for defining a desired spacing between a base layer of the ground surface and at least one of said first conditioning element and said second conditioning element to define a cushion layer.

11. The system of claim 1, further comprising a floating frame for supporting at least one of said first conditioning system and said second conditioning system to maintain desired contact with the ground surface.

12. The system of claim 11, further comprising a support frame having a mounting system for mounting said support frame to a vehicle, said floating frame being suspended from said support frame by a suspension system.

13. The system of claim 1, further comprising a third conditioning element adapted for conditioning a ground surface, said third conditioning element comprising a plurality of tines disposed in a support beam.

14. A system adapted for use with a vehicle for conditioning ground surfaces, the system comprising:
at least one conditioning element adapted for conditioning a ground surface;
a floating frame adapted for supporting said at least one conditioning system to maintain desired contact with the ground surface; and
a levelling system for defining a desired spacing between a base layer of the ground surface and said at least one conditioning element.

15. The system of claim 14, wherein said levelling system comprises at least one levelling component connected to said floating frame.

16. The system of claim 15, wherein said at least one levelling component is adjustable to vary the desired spacing between the base layer and said at least one conditioning element in order to define a cushion layer.

17. The system of claim 14, further comprising a support frame having a mounting system for mounting said support frame to a vehicle, said floating frame being suspended from said support frame by a suspension system.

18. A system adapted for use with a vehicle for conditioning ground surfaces, the system comprising:
a support frame having a mounting system for mounting said support frame to a vehicle;
a floating frame suspended from said support frame by a suspension system adapted to maintain desired contact with a ground surface;
a first conditioning element disposed on said floating frame and adapted for conditioning a ground surface, said first conditioning element being disposed at a first angle relative to a directional axis; and
a second conditioning element disposed on said floating frame and adapted for conditioning a ground surface, said second conditioning element being disposed at a second angle relative to said directional axis.

19. The system of claim 18, wherein said first conditioning element has a trailing edge that is offset from a leading edge of said second conditioning element relative to said directional axis.

20. The system of claim 18, further comprising a levelling system for defining a desired spacing between a base layer of the ground surface and at least one of said first conditioning element and said second conditioning element to define a cushion layer.
